(19) United States
(12) Patent Application Publication
(10) Pub. No.: US 2003/0095734 A1
(43) Pub. Date: May 22, 2003

(54) Method and device for transmitting an optical signal by polarization scrambling

(75) Inventors: Isao Nakajima, Kawasaki (JP); Sadao Ibukuro, Kawasaki (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 10/083,541

(22) Filed: Feb. 27, 2002

(30) Foreign Application Priority Data
Nov. 20, 2001 (JP) 2001-355048

(51) Int. Cl. G02B 6/27; G02B 6/293; H04J 14/06

(52) U.S. Cl. 385/11; 385/24; 359/122

(57) ABSTRACT

Disclosed herein is a device including a plurality of optical senders for generating a plurality of optical signals to which forward error correction is applied, a scrambler for polarization scrambling each of the optical signals output from the optical senders, and an optical multiplexer for wavelength division multiplexing the optical signals to obtain WDM signal light. A scrambling frequency in the scrambler is set higher than a natural frequency in the forward error correction. Accordingly, high-quality transmission is allowed without interchannel crosstalk in WDM transmission.

### BACKGROUND OF THE INVENTION

1. Field of the Invention

The present invention relates to a method and device for transmitting an optical signal by polarization scrambling.

2. Description of the Related Art

An optical communication system using an optical fiber transmission line is used to transmit a relatively large amount of information. A low-loss (e.g., 0.2 dB/km) optical fiber has already been produced and is being used as the optical fiber transmission line. In addition, an optical amplifier for compensating for loss in the optical fiber transmission line is used to allow long-haul transmission.

A conventional optical amplifier includes an optical amplifying medium pumped by pump light to provide a gain band. The optical amplifying medium and the pump light are selected so as to provide a gain band including the wavelength of signal light to be amplified. As a result, the signal light is amplified during propagation in the optical amplifying medium being pumped.

For example, an erbium doped fiber amplifier (EDFA) includes an erbium doped fiber (EDF) as the optical amplifying medium, and a pump source for pumping the EDF. The pump source supplies pump light having a predetermined wavelength to the EDF. By presetting the wavelength of the pump light within a 0.98 μm band or 1.48 μm band, a gain band including a wavelength band of 1.55 μm can be obtained. As a result, signal light having a wavelength band of 1.55 μm is amplified.

As a technique for increasing a transmission capacity by a single optical fiber, wavelength division multiplexing (WDM) is known. In a system adopting WDM, a plurality of optical carriers having different wavelengths are individually modulated by data. Each modulated carrier provides one channel of a WDM system for transmitting optical signals. These optical signals (i.e., the modulated carriers) are wavelength division multiplexed by an optical multiplexer to obtain WDM signal light. The WDM signal light thus obtained is transmitted through an optical fiber transmission line to a receiving end. At the receiving end, the WDM signal light is separated into individual optical signals by an optical demultiplexer. Then, the original data can be detected according to these individual optical signals.

Accordingly, by applying WDM, the transmission capacity in a single optical fiber can be increased according to the number of WDM channels. Furthermore, cross connect or the like utilizing the difference in wavelength is allowed, thereby facilitating the construction of a flexible system.

In recent years, a further increase in transmission capacity by dense wavelength division multiplexing (DWDM) has been tried. This technique is intended to effectively use an available wavelength band by narrowing the wavelength spacing of optical signals.

There is a problem of interchannel crosstalk due to narrowing of the wavelength spacing of optical signals. That is, there is a limit to the ability to wavelength demultiplexing of WDM signal light at a receiving end. As a result, interchannel crosstalk occurs when the difference in wavelength between two adjacent WDM channels is small.

Further, when the polarization planes of optical signals in two adjacent WDM channels coincide with each other, there is a case that a transmission quality is degraded by nonlinear optical effects.

To cope with this problems, it is proposed to maintain each optical signal at a linearly polarized state and make the polarization planes of optical signals in any two adjacent wavelength channels orthogonal to each other.

In this case, however, it is necessary to use polarization maintaining type optical devices as all the components arranged prior to wavelength division multiplexing, causing an increase in cost. As another method, it is considered to control the polarization plane of each optical signal immediately before wavelength division multiplexing. In this case, however, a complicated monitoring system, control circuit, etc. are required, still causing an increase in system cost.

Further, it may be proposed to polarization scramble each optical signal, thereby preventing the interchannel crosstalk. However, the polarization scrambling must be performed faster than the modulation of each optical signal. Accordingly, when the bit rate of each optical signal is high, the polarization scrambling is difficult.

### SUMMARY OF THE INVENTION

It is therefore an object of the present invention to provide a method and device allowing high-quality transmission without interchannel crosstalk.

In accordance with an aspect of the present invention, there is provided a method comprising the steps of generating a plurality of optical signals to which forward error correction is applied; polarization scrambling each of the optical signals; setting a scrambling frequency in the polarization scrambling step higher than a natural frequency in the forward error correction; and wavelength division multiplexing the optical signals to obtain WDM signal light.

Preferably, the natural frequency is the reciprocal of the period of block code lengths in the forward error correction.

According to this method, the polarization scrambling is performed at the frequency set higher than the natural frequency, so that high-quality transmission of the optical signals is allowed.

In accordance with another aspect of the present invention, there is provided a device comprising a plurality of optical senders for generating a plurality of optical signals to which forward error correction is applied; means for polarization scrambling each of the optical signals output from the optical senders; and an optical multiplexer for wavelength division multiplexing the optical signals to obtain WDM signal light; a scrambling frequency in the polarization scrambling means being set higher than a natural frequency in the forward error correction.

The above and other objects, features and advantages of the present invention and the manner of realizing them will become more apparent, and the invention itself will best be understood from a study of the following description and appended claims with reference to the attached drawings showing some preferred embodiments of the invention.

### BRIEF DESCRIPTION OF THE DRAWINGS

FIG. 1 is a block diagram showing a preferred embodiment of a transmitting terminal device to which the present invention is applicable;

FIG. 2 is a block diagram showing a preferred embodiment of a receiving terminal device applicable to the present invention;

FIG. 3 is a block diagram for illustrating the principle of polarization scrambling in the preferred embodiment shown in FIG. 1;

FIG. 4 is a diagram for illustrating a slow axis and a fast axis in a polarization maintaining fiber;

FIG. 5 is a diagram for illustrating a temporal change in polarization state;

FIG. 6 is a block diagram for illustrating a scrambling frequency in each phase modulator;

FIG. 7 is a block diagram showing another preferred embodiment of the transmitting terminal device to which the present invention is applicable; and

FIGS. 8A and 8B are diagrams for illustrating the principle of polarization scrambling in the preferred embodiment shown in FIG. 7.

### DETAILED DESCRIPTION OF THE PREFERRED EMBODIMENTS

Some preferred embodiments of the present invention will now be described in detail with reference to the attached drawings.

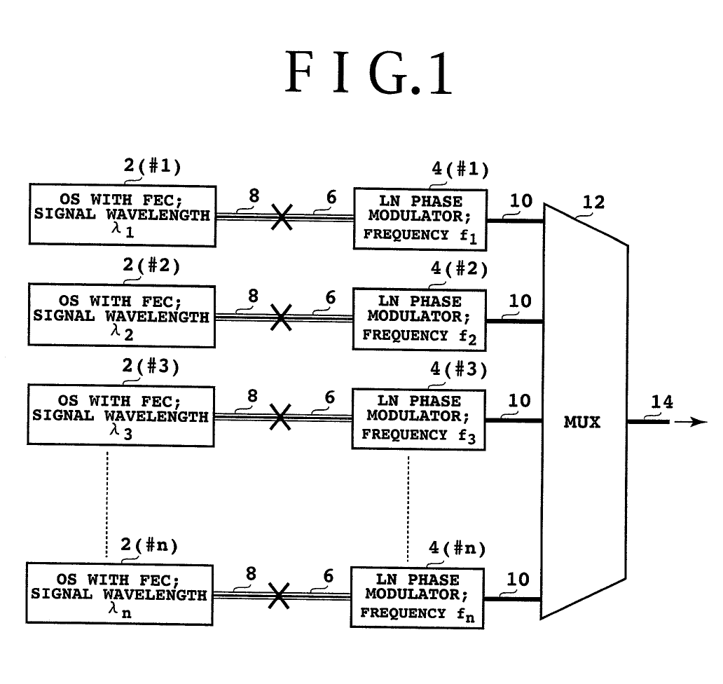

FIG. 1 is a block diagram of a transmitting terminal device to which the present invention is applicable. This transmitting terminal device is adapted to wavelength division multiplexing of n channels (n is an integer greater than 1). This transmitting terminal device includes n optical senders (OS) 2(#1) to 2(#n), n LN (lithium niobate) phase modulators 4(#1) to 4(#n), and an optical multiplexer (MUX) 12.

The optical senders 2(#1) to 2(#n) output optical signals having wavelengths λ₁ to λₙ as linearly polarized light from polarization maintaining fibers 8, respectively. The output ends of the polarization maintaining fibers 8 are spliced to the input ends of polarization maintaining fibers 6 as input ports of the phase modulators 4(#1) to 4(#n), respectively. The splicing of the polarization maintaining fibers 6 and 8 will be hereinafter described in detail.

Output ports of the phase modulators 4(#1) to 4(#n) are provided by single-mode fibers 10. The single-mode fibers 10 are connected to n input ports of the optical multiplexer 12. An output port of the optical multiplexer 12 is connected to an optical fiber transmission line 14.

Forward error correction (FEC) is applied to each of the optical senders 2(#1) to 2(#n). FEC is one of the methods for correcting transmission errors. More specifically, FEC is a method for error correction by transmitting redundant bits in addition to information bits and in the case that a part of the information bits becomes an error during transmission, utilizing the redundant bits to correct the error bit at a receiving end.

The polarization maintaining fibers 8 are spliced to the respective polarization maintaining fibers 6 so that the principal axis of each polarization maintaining fiber 8 is inclined 450 with respect to the principal axis of each polarization maintaining fiber 6. Each of the phase modulators 4(#1) to 4(#n) has different modulation efficiencies to a first polarization plane and a second polarization plane orthogonal to the first polarization plane. Accordingly, by the above-mentioned splicing of the polarization maintaining fibers 6 and 8, the optical signals output from the optical senders 2(#1) to 2(#n) are input into the respective phase modulators 4(#1) to 4(#n) so that the polarization plane of each optical signal is inclined 45° with respect to the first and second polarization planes.

The phase modulators 4(#1) to 4(#n) perform phase modulation to the input optical signals at frequencies f₁ to fₙ, respectively. Specific examples of the frequencies f₁ to fₙ will be hereinafter described.

The optical signals are thus phase-modulated by the phase modulators 4(#1) to 4(#n), thereby performing polarization scrambling. Further, the n-channel optical signals thus obtained are input into the optical multiplexer 12 to thereby obtain wavelength division multiplexed signal light (WDM signal light). The WDM signal light thus obtained is transmitted by the optical fiber transmission line 14.

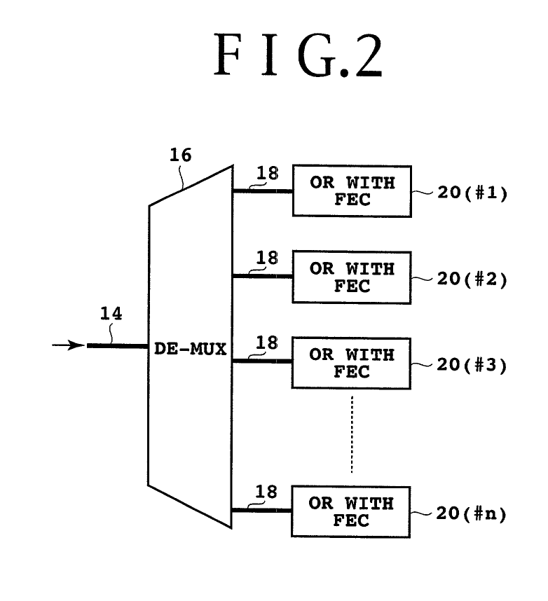

FIG. 2 is a block diagram of a receiving terminal device applicable to the present invention. The WDM signal light transmitted from the transmitting terminal device shown in FIG. 1 is input from the optical fiber transmission line 14 into an optical demultiplexer (DEMUX) 16. Although not shown, one or more optical amplifiers (e.g., erbium doped fiber amplifiers (EDFAs)) may be arranged along the optical fiber transmission line 14.

The input WDM signal light is separated into n-channel optical signals by the optical demultiplexer 16. The n-channel optical signals are next input through single-mode fibers 18 into optical receivers (OR) 20(#1) to 20(#n), respectively. FEC is applied to each of the optical receivers 20(#1) to 20(#n), thereby regenerating bit error corrected data.

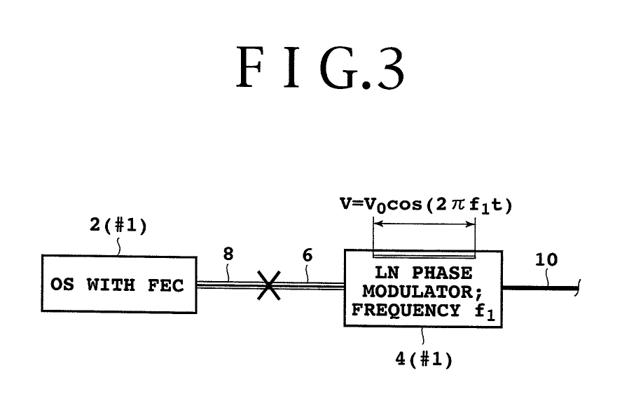

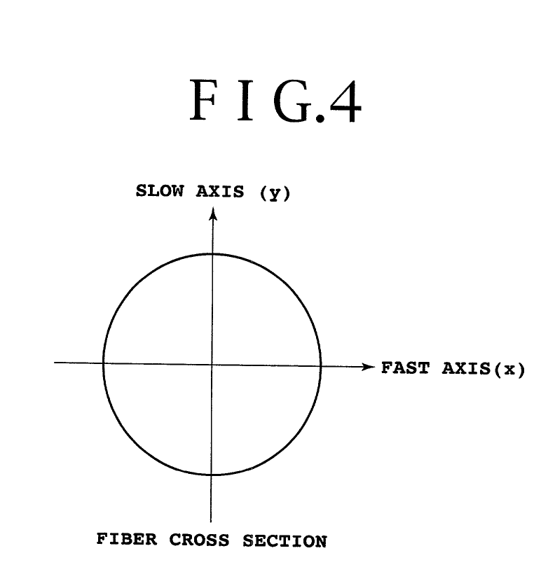

The principle of polarization scrambling will now be described with reference to FIGS. 3, 4, and 5. Each of the polarization maintaining fibers 6 and 8 has largely different refractive indices along two orthogonal axes as shown in FIG. 4. These two orthogonal axes are herein referred to as a fast axis (x-axis) and a slow axis (y-axis). For example, the optical signal output from the optical sender 2(#1) is linearly polarized light, and its polarization plane is parallel to the x-axis.

The polarization maintaining fiber 8 as the output port of the optical sender 2(#1) and the polarization maintaining fiber 6 as the input port of the phase modulator 4(#1) are spliced so that the principal axis of the polarization maintaining fiber 8 is inclined 45° with respect to the principal axis of the polarization maintaining fiber 6 wherein the principal axis of each polarization maintaining fiber is one of the fast axis and the slow axis. Accordingly, the optical signal input into the phase modulator 4(#1) is equally divided into an x-axis component and a y-axis component.

In the phase modulator 4(#1) employing lithium niobate, the modulation efficiency differs about twice between the TE mode and the TM mode. Accordingly, by temporally changing an applied voltage V=V₀cos(2πf₁t), an optical path difference or phase difference between the x-axis component and the y-axis component can be temporally changed. This will now be described more specifically.

The electric field components of light at the input of the phase modulator 4(#1) are written as follows:

Eₓ=E₀cos(ωt)

E_{y}=E₀cos(ωt)

On the other hand, the electric field components of light at the output of the phase modulator 4(#1) are written as follows:

Eₓ=E₀cos(ωt+δₓ)

E_{y}=E₀cos(ω^{t}+δ_{y})

Accordingly, the phase difference between the x-axis component and the y-axis component is given by the following equation.

δₓ−δ_{y}=φ(t)=φ₀cos(2πf₁t)

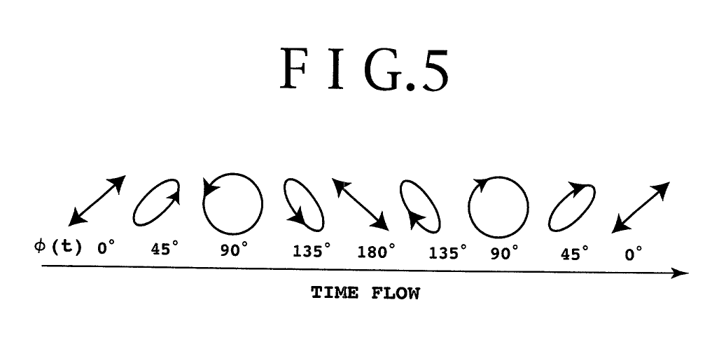

FIG. 5 shows a temporal change in polarization state in relation to this equation. As the phase difference between the x-axis component and the y-axis component changes from 0° to 45°, 90°, . . . , the polarization state changes from linear polarization to elliptical polarization, circular polarization, Accordingly, the optical signal undergoes polarization scrambling.

There will now be described a preferred example of the modulating frequencies in the phase modulators 4(#1) to 4(#n). In this preferred embodiment, the modulating frequency fᵢ in the phase modulator 4(#i) for the wavelength λᵢ (i is an integer satisfying 1≦i≦n) is set so as to satisfy F<fᵢ where F is the natural frequency of FEC, i.e., the reciprocal of the period of block code lengths of FEC. Further, the modulating frequency fⱼ in the phase modulator 4(#j) for the wavelength λⱼ (j is an integer satisfying i≠j) is set so as to satisfy F<|fᵢ−fⱼ|.

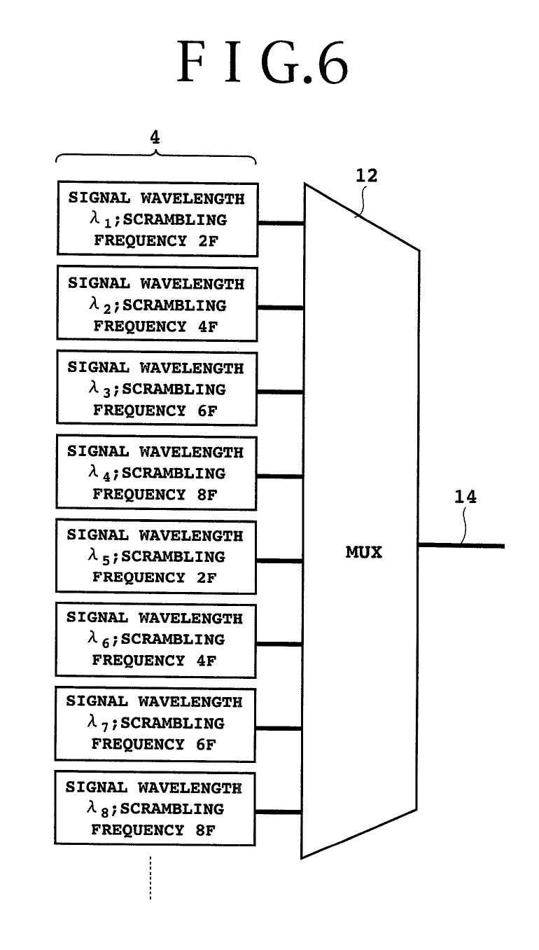

In the example shown in FIG. 6, the modulating frequencies f₁, f₂, f₃, and f₄ in the phase modulators 4(#1) to 4(#4) for the wavelengths λ₁, λ₂, λ₃, and λ₄ are set to 2F, 4F, 6F, and 8F, respectively, and the modulating frequencies f₅, f₆, f₇, and f₈ in the phase modulators 4(#5) to 4(#8) for the wavelengths λ₅, λ₆, λ₇, and λ₈ are set to 2F, 4F, 6F, and 8F, respectively. The other modulating frequencies are similarly repeated. In other words, in the range of any four adjacent wavelengths, the difference in scrambling frequency between any two of the four optical signals is greater than F.

By setting the scrambling frequencies as mentioned above, the mutual polarization states of the optical signals in a given wavelength region are randomized within the period of FEC, so that the transmission characteristics after FEC can be always uniformed.

Although the scrambling frequencies for any two wavelength channels spaced apart from each other with three wavelength channels interposed therebetween are the same (e.g., the scrambling frequencies for the wavelengths λ₄ and λ₈ are both 8F), there is no possibility of degradation of the transmission characteristics because these two wavelengths are sufficiently spaced apart from each other. Thus, it is not necessary to prepare the same number of kinds of scrambling frequencies as the number of wavelength channels. This is due to the fact that if the spacing of wavelength channels is sufficient, nonlinear effects such as XPM (cross-phase modulation) hardly occur even though the polarization planes are parallel. Further, when the spacing of wavelength channels is sufficient, crosstalk also hardly occurs in multiplexing and demultiplexing the optical signals.

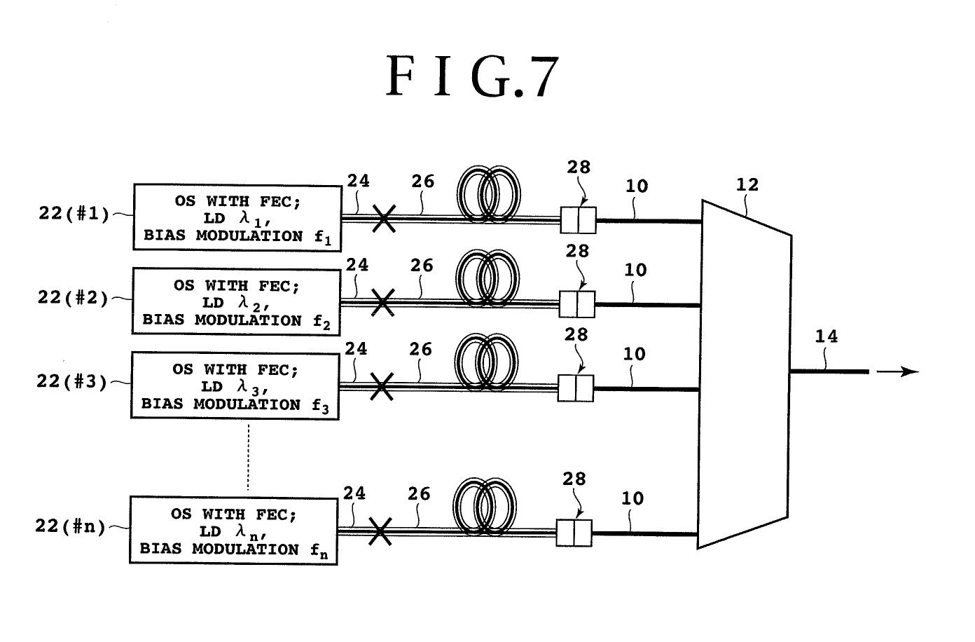

FIG. 7 is a block diagram showing another preferred embodiment of the transmitting terminal device to which the present invention is applicable. In this preferred embodiment, optical senders 22(#1) to 22(#n) for outputting frequency-modulated optical signals are used in place of the optical senders 2(#1) to 2(#n) shown in FIG. 1, and polarization maintaining fibers 26 each having a predetermined length are used in place of the phase modulators 4(#1) to 4(#n) shown in FIG. 1.

The optical senders 22(#1) to 22(#n) output optical signals having wavelengths λ₁ to λₙ, respectively. These optical signals having the wavelengths λ₁ to λₙ are preliminarily frequency-modulated at frequencies f₁ to fₙ, respectively. The frequency modulation may be performed by changing a bias current for a laser diode (LD) by a modulating signal, for example.

As the output ports of the optical senders 22(#1) to 22(#n), polarization maintaining fibers 24 are used. Like the preferred embodiment shown in FIG. 1, the polarization maintaining fibers 24 are spliced to the respective polarization maintaining fibers 26 so that the principal axis of each polarization maintaining fiber 24 is inclined 450 with respect to the principal axis of each polarization maintaining fiber 26. The polarization maintaining fibers 26 are optically connected through optical connectors 28 to the single-mode fibers 10 connected to the input ports of the optical multiplexer 12.

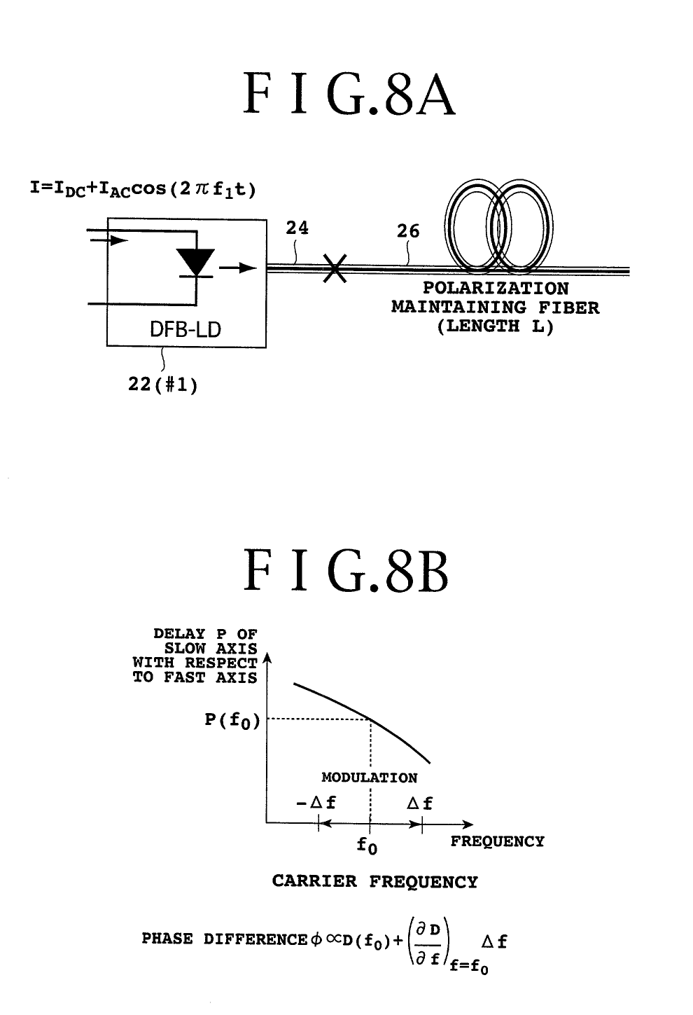

Referring to FIGS. 8A and 8B, there are shown the principle of polarization scrambling in the optical sender 22(#1) and the corresponding polarization maintaining fiber 26 shown in FIG. 7. When a drive current I=I_{DC}+I_{AC}cos(2πf₁t) is applied to a DFB-LD (distributed feedback laser diode) included in the optical sender 22(#1), intensity modulation by a binary signal can be performed by turning on and off the DC component I_{DC}, and frequency modulation at the frequency f₁ can be performed by varying the AC component I_{AC}cos(2πf₁t).

FIG. 8B shows the relation between frequency and a delay P of the slow axis with respect to the fast axis. With the variations in the AC component, the drive current I varies to thereby oscillate the frequency in the range of ±Δf (±f₁) with respect to a carrier frequency f0 as the center frequency. As a result, a phase difference φ as expressed at a lower position in FIG. 8B is obtained. In the expression of the phase difference φ, the first term on the right side represents a constant component, and the second term on the right side represents a modulation component.

According to this preferred embodiment, it is not required to use any active devices such as phase modulators as used in the preferred embodiment shown FIG. 1, thereby allowing a suppression of the cost of the device.

According to the present invention as described above, variations in transmission characteristics between channels and temporal fluctuations between channels can be suppressed to thereby allow high-quality transmission without interchannel crosstalk.

The present invention is not limited to the details of the above described preferred embodiments. The scope of the invention is defined by the appended claims and all changes and modifications as fall within the equivalence of the scope of the claims are therefore to be embraced by the invention.

What is claimed is:

1. A method comprising the steps of:
generating a plurality of optical signals to which forward error correction is applied;
polarization scrambling each of said optical signals;
setting a scrambling frequency in said polarization scrambling step higher than a natural frequency in said forward error correction; and
wavelength division multiplexing said optical signals to obtain WDM signal light.

2. A method according to claim 1, wherein said natural frequency is the reciprocal of the period of block code lengths in said forward error correction.

3. A method according to claim 1, wherein the difference in said scrambling frequency between two optical signals having adjacent wavelengths of said plurality of optical signals is higher than said natural frequency.

4. A method according to claim 1, wherein said polarization scrambling step comprises the step of providing a phase modulator for phase modulating each optical signal.

5. A method according to claim 4, wherein:
said phase modulator has different modulation efficiencies to a first polarization plane and a second polarization plane orthogonal to said first polarization plane;
each optical signal is linearly polarized light having a polarization plane; and
said polarization scrambling step further comprises the step of 45° inclining said polarization plane of each optical signal with respect to said first and second polarization planes.

6. A method according to claim 1, wherein said polarization scrambling step comprises the steps of frequency modulating each optical signal and transmitting said frequency-modulated optical signal through a birefringent optical medium.

7. A method according to claim 6, wherein:
said frequency modulating step comprises the step of modulating a bias current for a laser diode for outputting each optical signal as linearly polarized light having a polarization plane;
said birefringent optical medium comprises a polarization maintaining fiber having a fast axis and a slow axis orthogonal to said fast axis; and
said polarization scrambling step further comprises the step of 45° inclining said polarization plane of each optical signal with respect to said fast axis and said slow axis.

8. A method according to claim 1, further comprising the step of transmitting said WDM signal light by an optical fiber transmission line.

9. A method according to claim 8, further comprising the steps of:
separating said WDM signal light transmitted into a plurality of optical signals; and
decoding each of said optical signals obtained by said separating step, according to said forward error correction.

10. A device comprising:
a plurality of optical senders for generating a plurality of optical signals to which forward error correction is applied;
means for polarization scrambling each of said optical signals output from said optical senders; and
an optical multiplexer for wavelength division multiplexing said optical signals to obtain WDM signal light;
a scrambling frequency in said polarization scrambling means being set higher than a natural frequency in said forward error correction.

11. A device according to claim 10, wherein said natural frequency is the reciprocal of the period of block code lengths in said forward error correction.

12. A device according to claim 10, wherein the difference in said scrambling frequency between two optical signals having adjacent wavelengths of said plurality of optical signals is higher than said natural frequency.

13. A device according to claim 10, wherein said polarization scrambling means comprises a phase modulator for phase modulating each optical signal.

14. A device according to claim 13, wherein:
said phase modulator has different modulation efficiencies to a first polarization plane and a second polarization plane orthogonal to said first polarization plane;
each optical signal is linearly polarized light having a polarization plane; and
said polarization plane of each optical signal is inclined 45° with respect to said first and second polarization planes.

15. A device according to claim 10, wherein said polarization scrambling means comprises means for frequency modulating each optical signal and a birefringent optical medium for transmitting said frequency-modulated optical signal.

16. A device according to claim 15, wherein:
said frequency modulating means comprises means for modulating a bias current for a laser diode for outputting each optical signal as linearly polarized light having a polarization plane;
said birefringent optical medium comprises a polarization maintaining fiber having a fast axis and a slow axis orthogonal to said fast axis; and
said polarization plane of each optical signal is inclined 45° with respect to said fast axis and said slow axis.

17. A device according to claim 10, further comprising an optical fiber transmission line for transmitting said WDM signal light.

18. A device according to claim 17, further comprising:
an optical demultiplexer for separating said WDM signal light transmitted into a plurality of optical signals; and
means for decoding each of said optical signals output from said optical demultiplexer, according to said forward error correction.

19. A method according to claim 1, wherein said scrambring frequencies of any pairs of wavelength channels with some channels interposed therein are the same, as long as there is an enough space between the wavelengths sufficient for suppressing nonlinear effects and crosstalks.

20. A device according to claim 10, wherein said scrambring frequencies of any pairs of wavelength channels with some channels interposed therein are the same, as long as there is an enough space between the wavelengths sufficient for suppressing nonlinear effects and crosstalks.
